(19) United States
(12) Patent Application Publication
(10) Pub. No.: US 2017/0183023 A1
(43) Pub. Date: Jun. 29, 2017

(54) Automatic Balancing Variable Configuration Articulated Tracked Transporter

(71) Applicant: Keystone Strategy LLC, Cambridge, MA (US)

(72) Inventors: Greg Richards, New York, NY (US); Ty Boyce, Berkeley, CA (US); Akshay Goel, Jersey City, NJ (US)

(73) Assignee: Keystone Strategy LLC, Cambridge, MA (US)

(21) Appl. No.: 15/385,854

(22) Filed: Dec. 20, 2016

Related U.S. Application Data
(60) Provisional application No. 62/271,641, filed on Dec. 28, 2015.

(51) Int. Cl. B62B 5/02; B62B 5/00; B60K 17/04; B60W 30/095; B60R 11/04; B60K 1/02

(52) U.S. Cl. CPC B62B 5/02; B60R 11/04; B60K 1/02; B60K 17/046; B60W 30/0956; B62B 5/004; B62B 5/0053; B62B 5/0076

(57) ABSTRACT

A transporter has a chassis, a left wheel positioned at the bottom of the chassis, a right wheel positioned at the bottom of the chassis, a drive train with a left wheel motor to control the left wheel and a right wheel motor to control the right wheel, and a control system to control the left wheel motor and the right wheel motor to implement self-balancing propulsion of the transporter. The improvement is the utilization of a left primary pulley in a left pulley arm assembly forming a first belt assembly to traverse an obstacle and the utilization of a right primary pulley in a right pulley arm assembly forming a second belt assembly to traverse the obstacle.

### CROSS-REFERENCE TO RELATED APPLICATION

This application claims priority to U.S. Provisional Patent Application Ser. No. 62/271,641, filed Dec. 28, 2015, the contents of which are incorporated herein by reference.

### FIELD OF THE INVENTION

This invention pertains to tracked vehicles for transporting payloads, and more particularly, tracked vehicles with multiple configurations to traverse uneven surfaces and surmount obstacles.

### BACKGROUND OF THE INVENTION

A wide range of vehicles and methods are used for transporting payloads. The designs of these vehicles vary across a large spectrum to optimize for speed, range, terrain capabilities, payload size & weight, and/or maneuverability. Due to tradeoffs in optimizing each of these capabilities, and limitations in current designs, vehicles that transport payloads over rough surfaces or obstacles such as a staircase are generally not fully optimized for speed and maneuverability.

Simultaneously, developments in self-balancing platforms have allowed for the creation of very maneuverable, efficient vehicles with a small operational footprint.

Accordingly, it would be advantageous to provide a tracked vehicle with the capability to drive and dynamically balance on two wheels or deploy a variable angle track drive used in combination with the primary drive wheels, thus combining the ability of a tracked vehicle to traverse uneven surfaces with the ability of a two-wheeled, self-balancing platform to deftly maneuver.

One design available is a two wheeled self-balancing vehicle. However it is limited in its ability to climb over obstacles such as stairs. The maximum height of an obstacle it can climb over is limited by the diameter of the drive wheels (approximately 70% of the drive wheel radius), and there is significant instability in self-balancing vehicles as the height of the obstacle approaches this limit.

Another class of current designs has four drive wheels with two tracks, one on each side of the chassis following a path around the two drive wheels on the respective side. The designs incorporate two tracked “flippers” (i.e., arms with pulleys and separate additional tracks) on the front of the chassis to facilitate climbing over obstacles. In these designs, the flipper pulleys are not able to follow a path of rotation that fully circumscribes the chassis due to the chassis interfering with the flipper's motion. As a consequence, these designs have several limitations: i) they demand four flippers, two front, and two back, to allow both forward and backward traversal of obstacles; and ii) each flipper and flipper track requires two additional drive means for each flipper arm, one to drive the flipper's track, and the other to position the angle of the flipper arm. This makes the designs expensive and unnecessarily complex.

Another more advanced design utilizes two tracks, four drive wheels and two planetary pulleys or gears. The planetary pulleys are attached in a manner that allows them to follow a path that fully circumscribes the chassis and four drive wheels. Two tracks, one on each side, follow a path around the two drive wheels and the planetary pulley on the respective side. As the planetary pulley rotates around the chassis, it must follow an elliptical path to ensure that the track remains at a constant length and tension. As a result, this design incorporates a complex elliptical cam, or other complex mechanism design, to allow the planetary pulleys to circumscribe the two drive wheels on their respective sides in elliptical paths that maintain a constant or near constant track length.

None of these classes of existing designs for climbing over obstacles incorporate a self-balancing mechanism capable of balancing the payload attitude above a single pair of drive wheels. Hence they all require four drive wheels, and a straight section of track in contact with the ground. This makes rotation in place difficult, because the straight section of track must skid along the ground as the transporter rotates in place.

### SUMMARY OF THE INVENTION

A transporter has a chassis, a left wheel positioned at the bottom of the chassis, a right wheel positioned at the bottom of the chassis, a drive train with a left wheel motor to control the left wheel and a right wheel motor to control the right wheel, and a control system to control the left wheel motor and the right wheel motor to implement self-balancing propulsion of the transporter. The improvement is the utilization of a left primary pulley in a left pulley arm assembly forming a first belt assembly to traverse an obstacle and the utilization of a right primary pulley in a right pulley arm assembly forming a second belt assembly to traverse the obstacle.

### BRIEF DESCRIPTION OF THE DRAWINGS

The invention is more fully appreciated in connection with the following detailed description taken in conjunction with the accompanying drawings, in which:

FIG. 1 is a front view of a transporter configured in accordance with an embodiment of the invention.

FIG. 2 is a side view of a transporter configured in accordance with an embodiment of the invention.

FIG. 3 is a perspective view of a transporter configured in accordance with an embodiment of the invention.

FIG. 4 is an open view of a transporter configured in accordance with an embodiment of the invention.

FIG. 5 depicts a control and sensor system configured in accordance with an embodiment of the invention.

FIG. 6 illustrates a drive train utilized in accordance with an embodiment of the invention.

FIG. 7 illustrates a gear system utilized in accordance with an embodiment of the invention.

FIG. 8 is an exploded view of the gear system of FIG. 7.

FIG. 9 illustrates a center line and attitude line associated with a configuration of the transporter.

FIGS. 10-18 illustrate multiple configurations of the relative position of the driven wheels, the planetary pulley arms, and the chassis of the transporter in consecutive phases of stair climbing.

FIGS. 19-20 illustrates self-correcting orientation of the transporter while traversing a large obstacle.

FIGS. 21-22 illustrate alternate embodiments of the invention that use belt assemblies attached to primary pulleys instead of attachment to wheels.

FIG. 23 illustrates a drive train utilized in accordance with an alternate embodiment of the invention

FIG. 24 illustrates a gear system utilized in accordance with an alternate embodiment of the invention

FIG. 25 is an exploded view of the gear system of FIG. 24.

FIG. 26 illustrates an alternate embodiment with weights attached to the pulley arms

Like reference numerals refer to corresponding parts throughout the several views of the drawings.

### DETAILED DESCRIPTION OF THE INVENTION

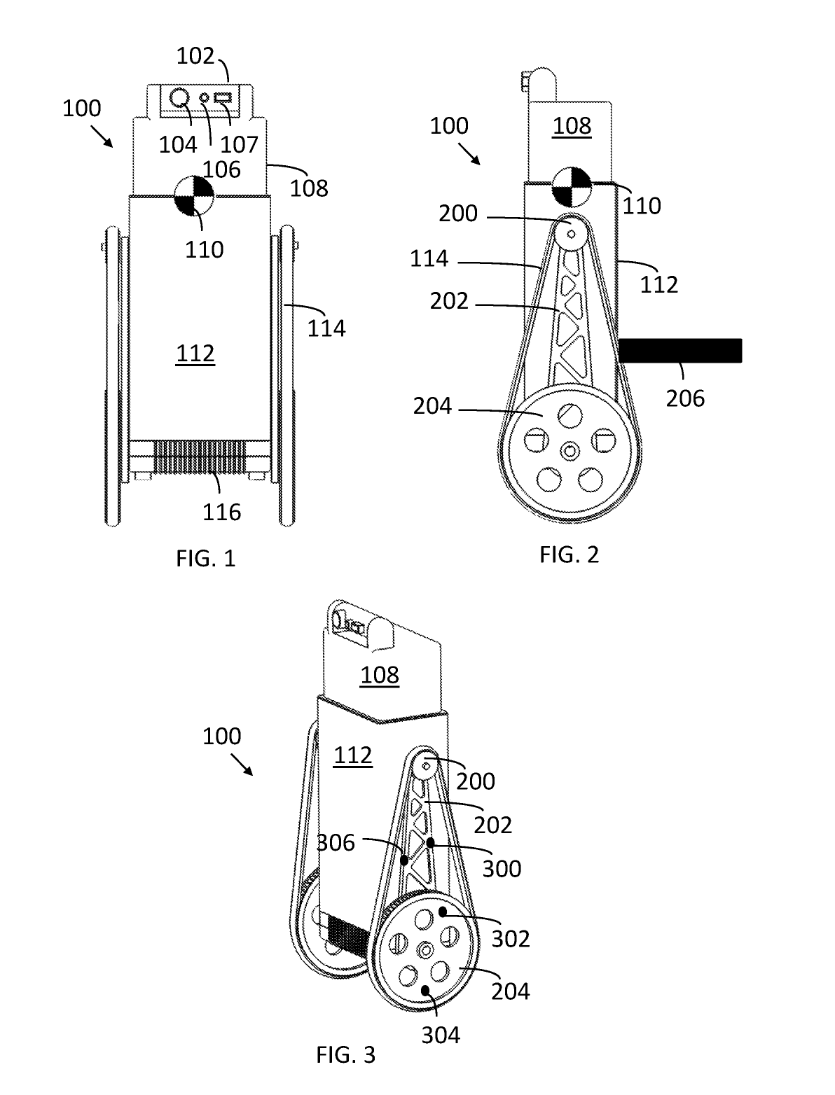

FIG. 1 illustrates a transporter 100 configured in accordance with an embodiment of the invention. The transporter 100 includes a sensor panel 102 that hosts any number of sensors, such as a camera 104, sonar sensor 106 and laser 107. A sensor housing 108 hosts additional sensors, as discussed below.

Point 110 represents the center of gravity (CG) for the transporter 100, i.e., the combination of the payload and chassis. The significance of this location is discussed below.

The transporter also includes a chassis 112 that may be used to transport a payload. A belt 114 is associated with a drive wheel, as discussed below. Finally, FIG. 1 also illustrates a drive train 116, details of which are discussed below.

FIG. 2 is a side view of the transporter 100. In addition to elements discussed in connection with FIG. 1, the figure illustrates a freely rotating pulley 200, a pulley arm 202 and a drive wheel 204. The figure also illustrates a possible position for a platform 206 that may be used to carry a human.

The drive wheel 204 is one of two wheels associated with the transporter. The two drive wheels have associated motors that are controlled by a control system to implement self-balancing propulsion. Two wheel systems that implement self-balancing propulsion are known in the art. Segway, Inc. of Bedford, N.H. sells a variety of such devices. However, prior art devices do not utilize such drive wheels in pulley arm assemblies (e.g., a left pulley arm assembly comprising drive wheel 204, pulley arm 202, freely rotating pulley 200 and drive belt 114). As discussed below, left and right pulley arm assemblies form first and second belt assemblies that are used to traverse an obstacle.

FIG. 3 is a perspective view of the transporter 100. In addition to elements discussed in connection with FIGS. 1 and 2, the figure illustrates a pulley arm torque sensor 300. The pulley arm torque sensor 300 provides pulley arm torque signals that are processed while the transporter traverses an obstacle. Such signals can be compared against thresholds to insure that the transporter is operated within safe margins.

FIG. 3 also illustrates a drive wheel torque sensor 302. The drive wheel torque sensor 302 provides drive wheel torque signals that are processed while the transporter traverses an obstacle. Such signals can be compared against thresholds to insure that belt operation is appropriate and that the transporter is operated within safe margins.

FIG. 3 also illustrates a drive wheel speed sensor 304. The drive wheel speed sensor 304 provides drive wheel speed signals that may be compared to signals from the drive motor to confirm that expected speed is obtained.

Finally, FIG. 3 illustrates a pulley arm position sensor 306. The pulley arm position sensor 306 provides pulley arm position signals that are compared to signals from a pulley arm drive motor to confirm that an expected position is reached. The speed and position of the drive wheels and pulley arm can be determined at a high resolution through motor mounted encoders.

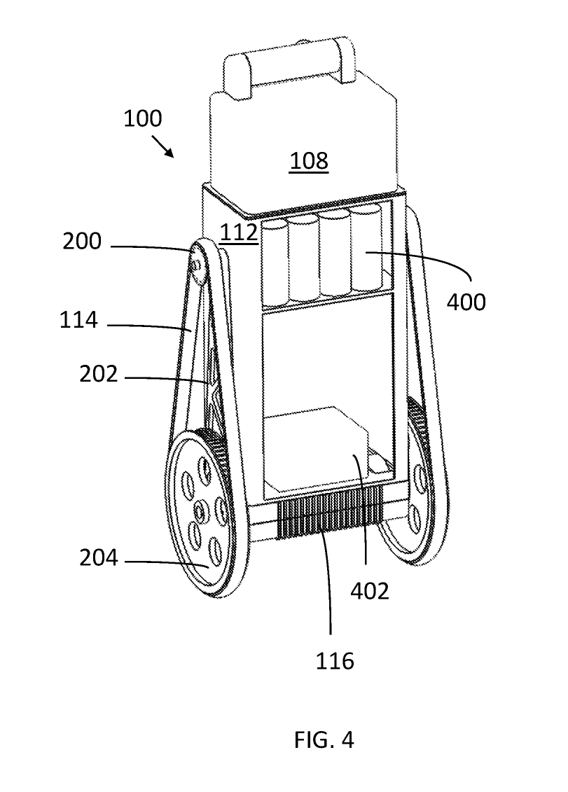

FIG. 4 is a view of the transporter 100 with the chassis 112 open. Inside the chassis 112 is a set of batteries 400 and a control system 402. The control system 402 coordinates the operations discussed herein. In particular, the control system 402 implements known self-balancing propulsion of a two wheel device. In addition, the control system 402 implements manipulation of pulley arms to facilitate traversal of an obstacle by first and second belt assemblies.

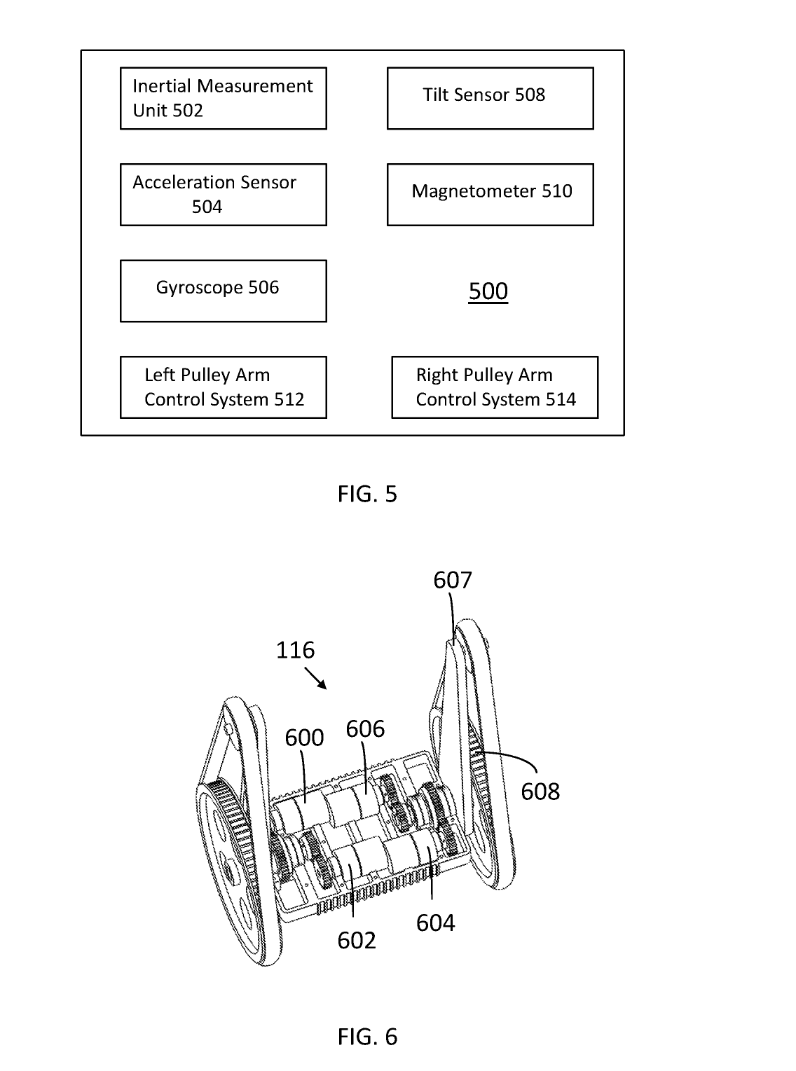

FIG. 5 illustrates a control and sensor system 500 utilized in accordance with an embodiment of the invention. In addition to the sensors discussed in connection with FIG. 3, the transporter 100 may include an inertial measurement unit 502. The inertial measurement unit 502 characterizes orientation, dynamic stability, and the angle between a plane passing through the CG and the points of surface contact of the drive wheels, referred to as the attitude of the chassis. The sensor system 500 also includes at least one acceleration sensor 504, such as a Silicon based three-axis acceleration sensor (accelerometer). The sensor system 500 also includes at least one gyroscope 506, such as an electro-mechanical system (MEMS) chip configured as a three-axis gyroscope. Redundant gyroscopes may be arranged such that a pair of sensors can be used to deduce roll, pitch and yaw. This facilitates self-balancing of the transporter 100.

The input signals from the acceleration sensors and gyroscopes can be compared against expected input signals. The difference in these values can be used to generate simple wheel motion or configuration changes of the transporter. These configuration changes can be speed and/or position changes on one or both wheels, attitude of the chassis, and orientation of the planetary pulley arms.

The sensor system 500 may also include at least one tilt sensor 508. Redundant tilts sensor may be used to sense pitch and yaw. The sensor system 500 may also include at least one three-axis magnetometer 510 to measure strength and direction of a magnetic field at a point in space. Silicon Sensing of Plymouth, Devon, United Kingdom sells sensor of the type disclosed.

The signals from the sensors of FIG. 4 and FIG. 5 may be processed by a left pulley control system 512 and a right pulley control system 514 to implement the disclosed dual belt assembly traversal of objects.

FIG. 6 illustrates an embodiment of the drive train 116. In one embodiment, the drive train 116 includes a left pulley motor 600 and a left wheel motor 602. The left pulley motor 600 manipulates the pulley arm 202. The left wheel motor 602 controls the drive wheel 204. In one aspect, the drive wheel 204 is operated in a conventional manner when implementing self-balancing propulsion of the transporter. However, in another aspect, the drive wheel is operated in a non-conventional manner to drive a belt assembly to coordinate the traversal of an obstacle. The drive train 116 also includes a right pulley motor 604 and a right wheel motor 606 to respectively drive a right pulley arm 607 and a right drive wheel 608. The individual motors of drive train 116 may be operated in independent or coordinated manners.

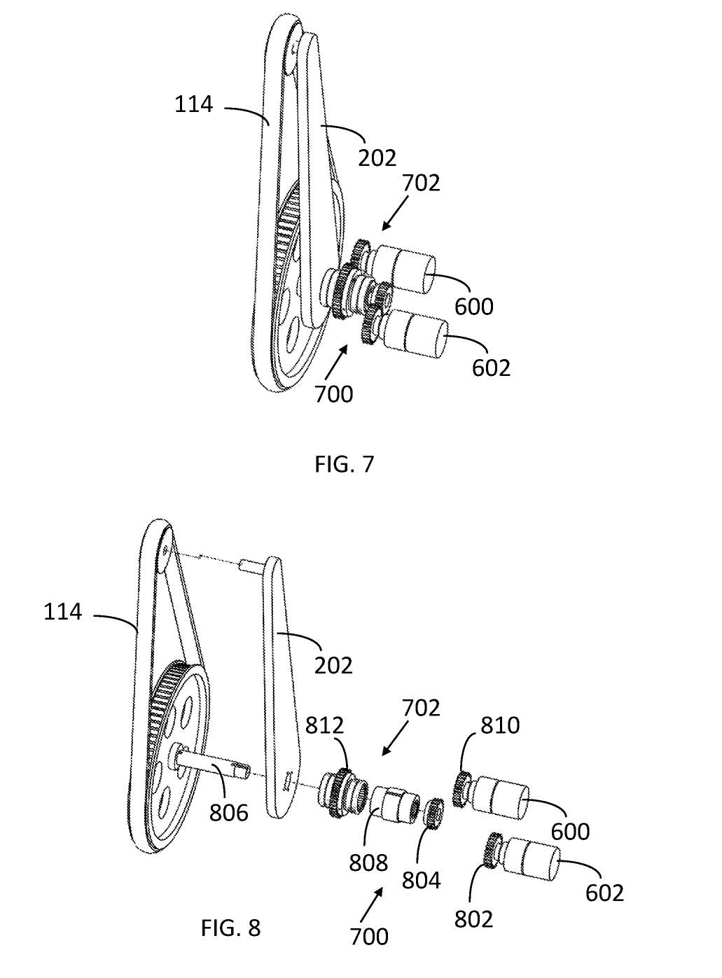

FIG. 7 illustrates a left wheel motor gear system 700 and a left pulley motor gear system 702. The right wheel may have a similar system.

FIG. 8 is an exploded view of the components of FIG. 7. The left wheel motor gear system 700 includes a left motor gear 802, which drives a left wheel shaft gear 804, which is attached to left wheel shaft 806. The left wheel shaft 806 hosts a wheel shaft sleeve 808. The left pulley motor gear system 702 includes a left motor gear 810, which drives left arm gear 812, which is affixed to pulley arm 202.

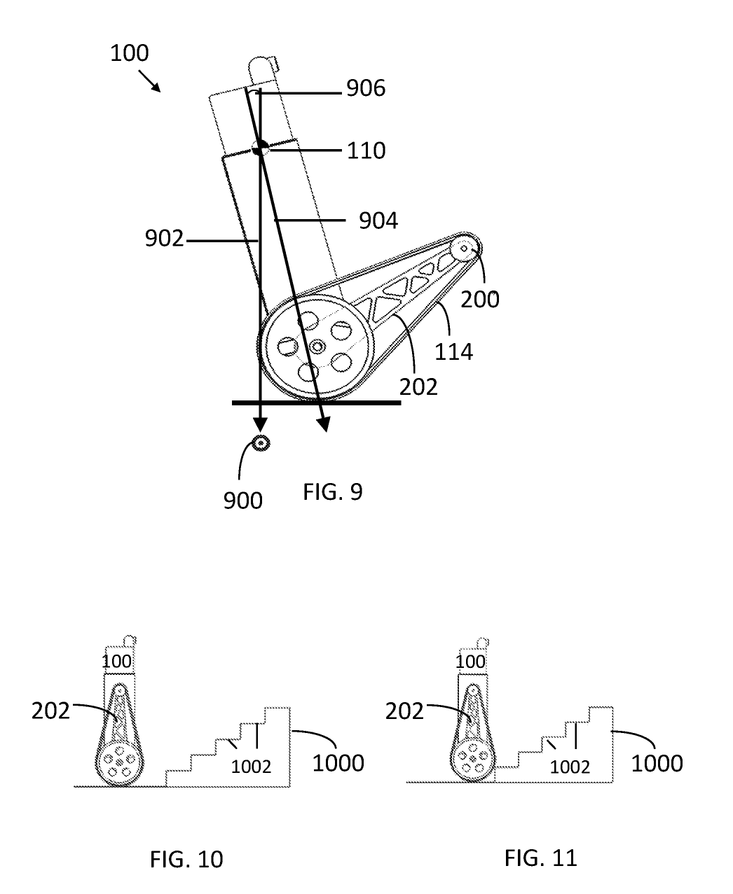

FIG. 9 illustrates the transporter 100 and its center of gravity 110, which establishes a center line 902 with earth center 900. An attitude line 904 represents the attitude of the transporter 100. The orientation between the center line 902 and attitude line 904 forms an attitude angle 906.

FIG. 10 illustrates the transporter 100 approaching an obstacle in the form of a staircase 1000 with stairs 1002. The pulley arm 202 is in a vertical orientation. Pulley arm 202 is a left pulley arm associated with a first or left belt assembly. The right pulley arm (not shown in FIG. 10) and its associated with second or right belt assembly may have an identical orientation or may be independently oriented.

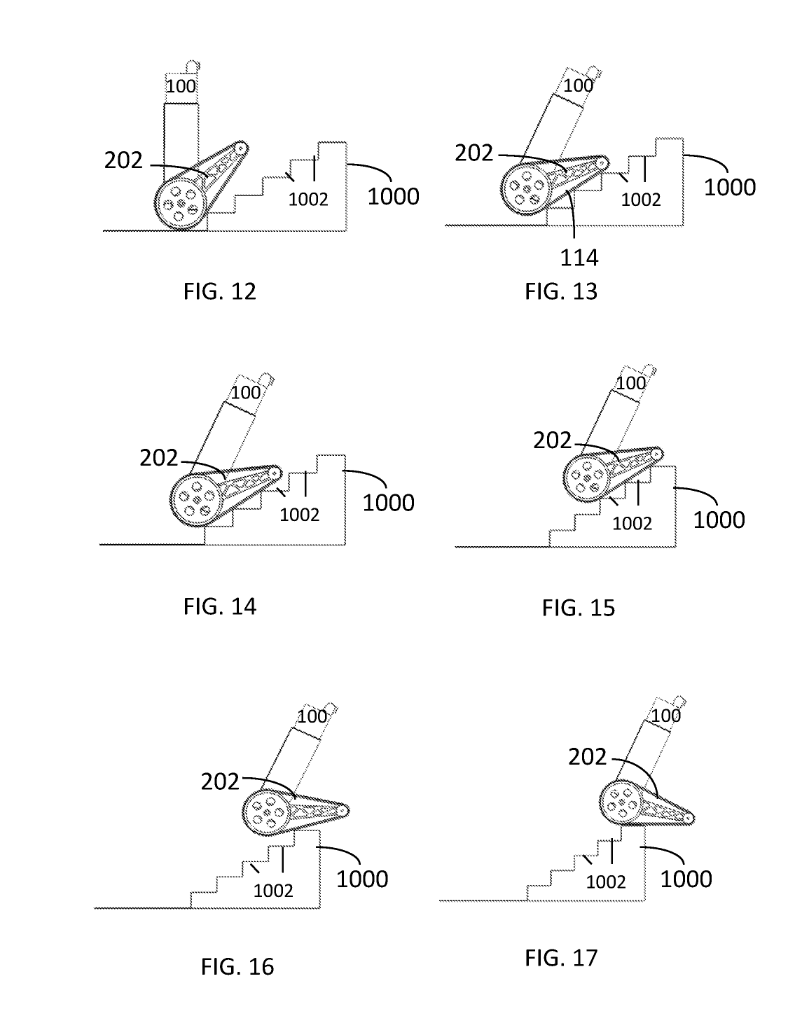

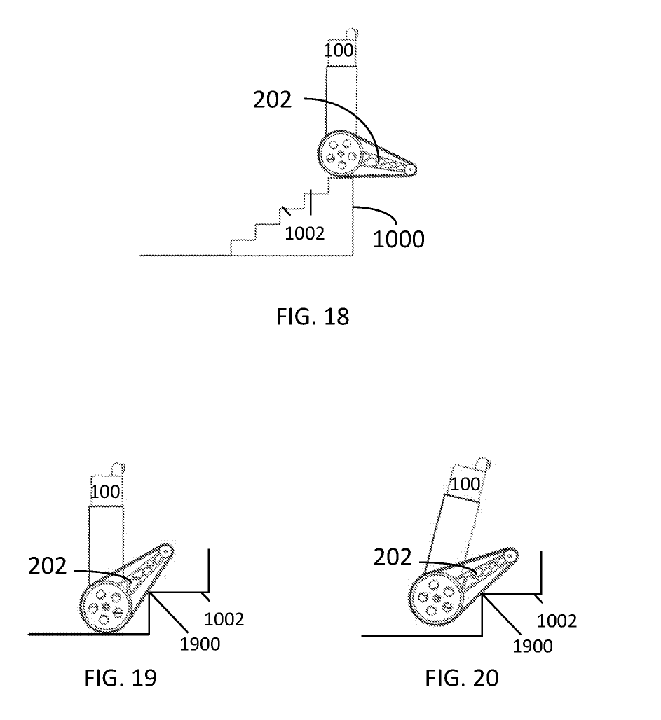

FIG. 11 illustrates the transporter 100 making initial contact with the staircase 1000, which initiates a climb operation. FIG. 12 illustrates the movement of the pulley arm 202 to facilitate the climb operation. FIG. 13 illustrates the transporter 100 with the attitude adjusted such that the CG is dynamically stabilized above the points of contact of the drive belt with the staircase 1000. The figure also illustrates the belt 114 engaging stairs 1002 of the staircase 1000. FIGS. 14 and 15 illustrate the progression of the transporter 100 up the staircase 1000. FIG. 16 illustrates the transporter 100 reaching the top stair of the staircase 1000. FIG. 17 illustrates full engagement between the belt 114 and the top stair. FIG. 18 illustrates the progression of the transporter 100 over the top stair and the repositioning of the attitude of the transporter 100 at a vertical orientation.

For traversal of obstacles, the accelerometers and gyroscopes that facilitate balancing on the drive wheel need to work in concert with the torque and position sensors of the planetary arms, in order to allow the transporter to balance on the point of the drive belt that first comes in contact with the obstacle 1900 as illustrated in FIG. 19. Without the ability to coordinate the position of the CG relative to the angle of the pulley arms, the vehicle would gradually stand up straight and eventually fall over backward. However, by coordinating the self-balancing sensors with the torque and position sensors, the transporter can translate the CG of the system until it is vertically above the portion of the track that is in contact with the obstacle as illustrated in FIG. 20. That is, FIG. 20 illustrates re-orientation of the transporter 100 for proper balance with respect to a larger obstacle 1900. This configuration can be employed to then allow the drive wheels to propel the transporter over the obstacle even with one point of balancing on the drive belt.

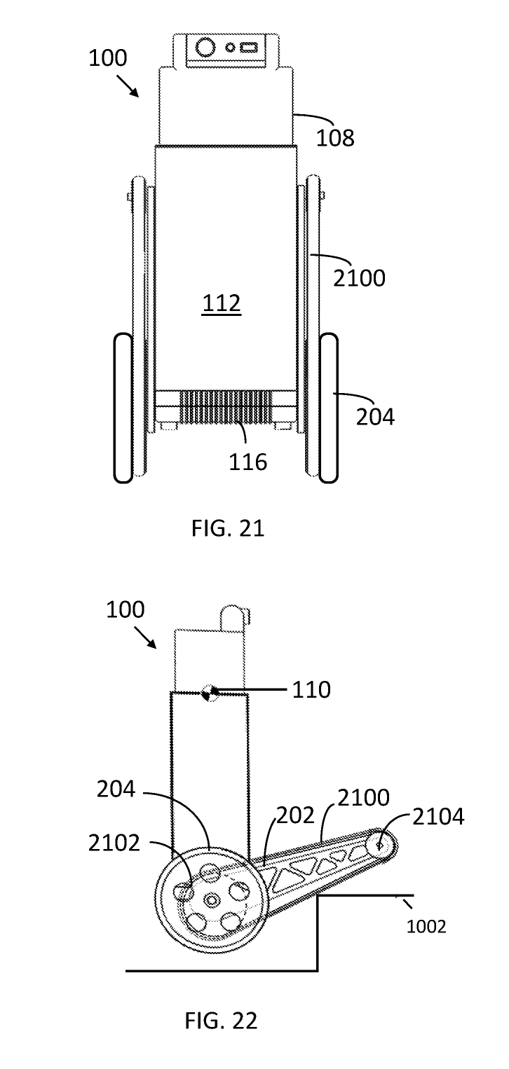

FIG. 21 illustrates an alternate embodiment of the invention in which each belt 2100 is connected to a primary pulley that is separate from wheel 204. FIG. 22 is a side view of this embodiment. The figure shows a pulley arm 202 supporting a primary pulley 2102 and a rotating pulley 2104 that is motor driven. That is, unlike the prior embodiments that utilized a freely rotating pulley, in this embodiment, both the primary pulley 2102 and the secondary pulley 2104 each have an associated motor to control the operation and orientation of the pulley arm 202. The primary pulley 2012 is separate from the wheel 204.

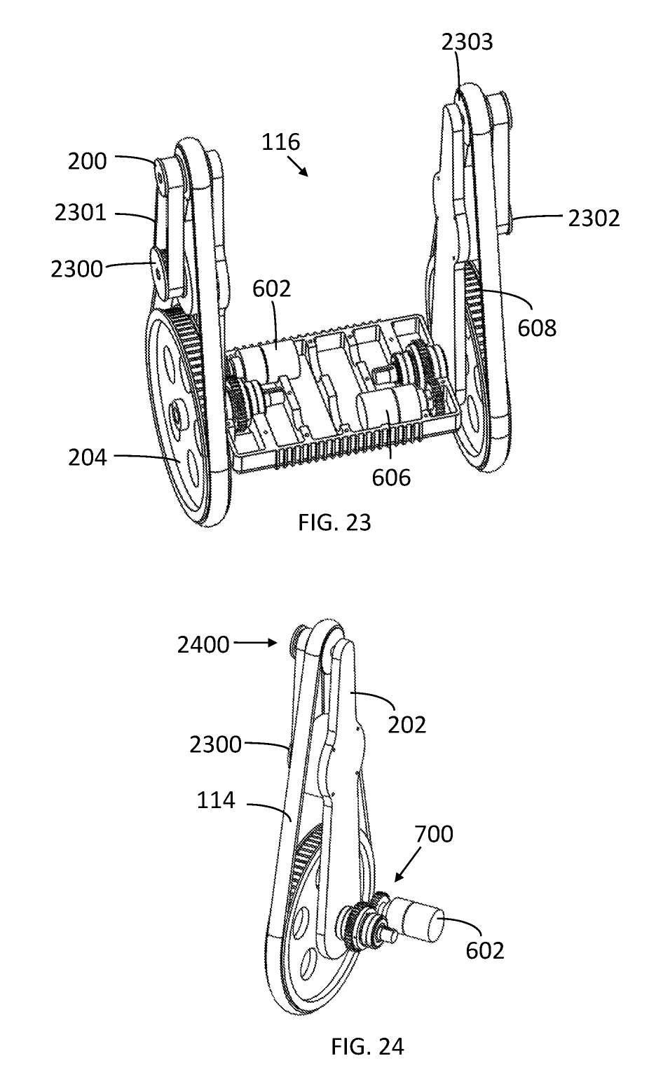

FIG. 23 illustrates an alternate embodiment of the drive train 116. In this embodiment, the drive train 116 includes a left pulley motor 2300 and a left wheel motor 602. The left pulley motor 2300 manipulates the first rotating pulley 200. The left wheel motor 602 controls the drive wheel 204. In one aspect, the drive wheel 204 is operated in a conventional manner when implementing self-balancing propulsion of the transporter. However, in another aspect, the drive wheel is operated in a non-conventional manner to drive a belt assembly 2301 to coordinate the traversal of an obstacle. The drive train 116 also includes a right pulley motor 2302 and a right wheel motor 606 to respectively drive a second rotating pulley 2303 and a right drive wheel 608. The individual motors of drive train 116 may be operated in independent or coordinated manners.

FIG. 24 is a view of a left wheel motor gear system 700 and a left pulley motor gear system 2400. The right wheel may have a similar system.

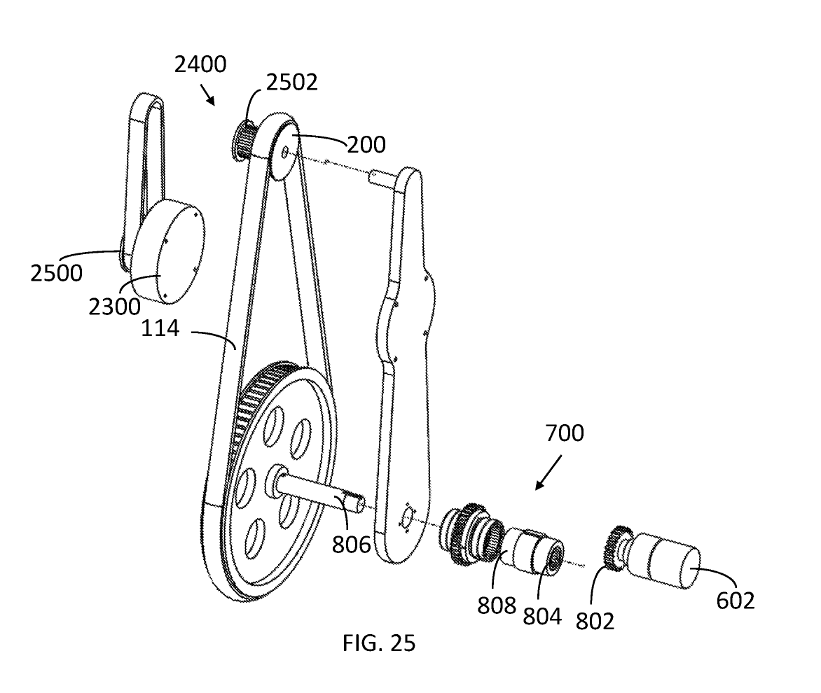

FIG. 25 is an exploded view of the components of FIG. 24. The left wheel motor gear system 700 includes a left motor gear 802, which drives a left wheel shaft gear 804, which is attached to left wheel shaft 806. The left wheel shaft 806 hosts a wheel shaft sleeve 808. The left pulley motor gear system 2400 includes a left motor gear 2500, which drives first rotating pulley gear 2502, which is affixed to pulley 200.

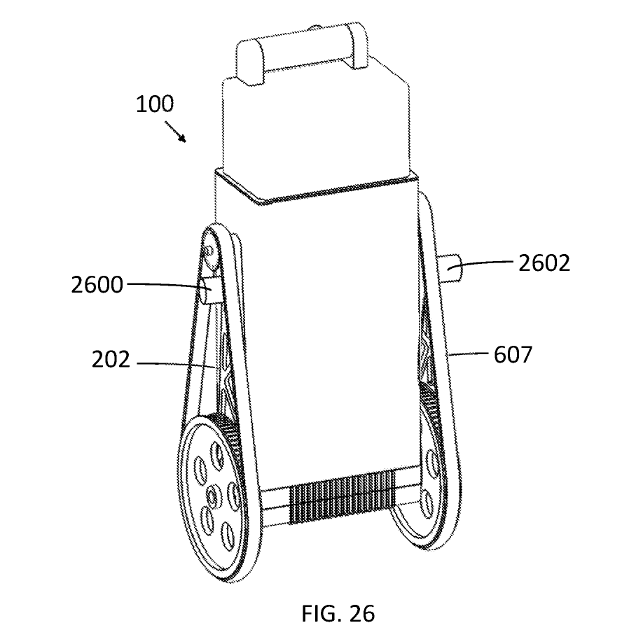

FIG. 26 illustrates an alternate embodiment where the left pulley arm 202 incorporates an attached weight 2600 and the right pulley arm 607 incorporates an attached weight 2602. The weights increase the inertia of the pulley arms and allow the arms to function as a counterbalance to augment the dynamic stability of the transporter when it is implementing self-balancing propulsion.

The transporter 100 may be configured for dynamic autonomous operation responsive to an obstacle, as described. Alternately, the transporter may be configured for programmed control along a predetermined path. The transporter may also be configured to be responsive to remote control, such as through a console or mobile device. The transporter may also be configured for telepresence control, such that a remote individual observes the operating environment and remotely controls the transporter to respond to the operating environment.

Thus, the transporter 100 has two drive wheels, two planetary pulleys and two tracks or belts. The design eliminates the need for complex mechanics associated with elliptical cams.

The design includes a chassis capable of carrying a payload within it or riding on it (e.g., riding on platform 206). The weight of the payload and chassis together has an average location which is a point defined as the center of gravity 110 of the chassis and payload. The design allows the center of gravity to be positioned vertically in height relative to the transverse axis of the drive wheels.

The chassis and payload can have an orientation relative to the surface being traversed, called an attitude (referred to as the attitude angle θ). The attitude angle 906 represents the angle between the center line 902 and the attitude line 904 (the actual ground contacting members and the surface would not be perfectly rigid and the attitude described uses the common sense theoretical single point of contact between the drive wheels and the surface).

The design allows for varying the attitude and the position of the planetary arms for purposes of balancing, overcoming obstacles and traversing surfaces at faster speeds than existing designs. The design eliminates the difficulty experienced by other designs in turning because it can balance and turn using only the two drive wheels, while holding the planetary arms and lengths of track between the drive wheels and planetary gears out of contact with the surface. The design thus enables in place rotation and maneuverability in more confined spaces.

The design also allows for positioning the attitude at greater angles for overcoming larger obstacles and for traversing surfaces at faster speeds compared to existing designs.

The design also overcomes the limitation with respect to climbing over obstacles of two wheeled self-balancing vehicles. It does so with the use of the planetary pulleys, pulley arms and tracks. The tracks create an effective wheel diameter that is much larger than the drive wheel diameter, allowing the transporter to smoothly climb steep stair cases and other obstacles. This ability is aided not only by the track system, but also by the device's ability to move its center of gravity into a position that is advantageous for climbing or surmounting a given obstacle.

An embodiment has separate drive means for each planetary arm. The transporter 100 is capable of differential positioning of the planetary arms so that the leading arm that first comes to the edge of a surface might touch the surface first and the trailing arm might be even lower. This enables it to climb stairs or uneven surfaces while approaching them at any angle.

The design can also use the planetary pulley arms to correct its position and autonomously stand vertically if the chassis falls to a horizontal position relative to the traversed surface.

The planetary arms can also be used to apply a force counterbalancing the force applied by the controller and governed by the torque, speed, and acceleration sensors, to provide an even finer degree of dynamic stability to the primary load while in motion.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A transporter has a chassis, a left wheel positioned at the bottom of the chassis, a right wheel positioned at the bottom of the chassis, a drive train with a left wheel motor to control the left wheel and a right wheel motor to control the right wheel, and a control system to control the left wheel motor and the right wheel motor to implement self-balancing propulsion of the transporter, the improvement comprising:
a left pulley arm with a first left pulley arm end and a second left pulley arm end, the first left pulley arm end supports a first rotating pulley and the second left pulley arm end supports a left primary pulley;
a first belt is attached to the first rotating pulley and the left primary pulley to form a first belt assembly;
a left pulley motor controls the orientation of the left pulley arm;
a left pulley control system controls the left pulley motor to coordinate the orientation of the left pulley arm to facilitate utilization of the first belt assembly to traverse an obstacle;
a right pulley arm with a first right pulley arm end and a second right pulley arm end, the first right pulley arm end supports a second rotating pulley and the second right pulley arm end supports a right primary pulley;
a second belt is attached to the second rotating pulley and the right primary pulley to form a second belt assembly;
a right pulley motor controls the orientation of the right pulley arm; and
a right pulley control system controls the right pulley motor to coordinate the orientation of the right pulley arm to facilitate utilization of the second belt assembly to traverse the obstacle.

2. The transporter of claim 1 wherein the left primary pulley is the left wheel and the right primary pulley is the right wheel.

3. The transporter of claim 1 wherein the first rotating pulley and the second rotating pulley freely rotate.

4. The transporter of claim 1 wherein the first rotating pulley and the second rotating pulley are each motor driven.

5. The transporter of claim 1 further comprising a camera positioned on the chassis.

6. The transporter of claim 1 further comprising a sonar sensor positioned on the chassis.

7. The transporter of claim 1 further comprising a laser positioned on the chassis.

8. The transporter of claim 1 further comprising a pulley arm torque sensor.

9. The transporter of claim 1 further comprising a pulley arm position sensor.

10. The transporter of claim 1 further comprising a drive wheel torque sensor.

11. The transporter of claim 1 further comprising a drive wheel speed sensor.

12. The transporter of claim 1 further comprising an inertial measurement unit.

13. The transporter of claim 1 further comprising a three-axis acceleration sensor.

14. The transporter of claim 1 further comprising a three-axis gyroscope.

15. The transporter of claim 1 further comprising a three-axis magnetometer.

16. The transporter of claim 1 configured for remote control.

17. The transporter of claim 1 configured for telepresence control.

18. The transporter of claim 1 configured for programmed control along a pre-determined path.

19. The transporter of claim 1 configured for dynamic autonomous operation responsive to the obstacle.

20. The transporter of claim 1 further comprising batteries within the chassis.

21. The transporter of claim 1 further comprising a left pulley arm counterbalance weight and a right pulley arm counterbalance weight to facilitate increased dynamic stability of the transporter during self-balancing propulsion.
